(19) United States
(12) Patent Application Publication
(10) Pub. No.: US 2025/0198081 A1
(43) Pub. Date: Jun. 19, 2025

(54) INDIGO-FREE FABRIC WITH DENIM VISUAL APPEARANCE

(71) Applicant: Swiss Performance Chemicals AG, Muttenz (CH)

(72) Inventor: Mickael MHEIDLE, Sausheim (FR)

(73) Assignee: Swiss Performance Chemicals AG, Muttenz (CH)

(21) Appl. No.: 19/073,518

(22) Filed: Mar. 7, 2025

Related U.S. Application Data
(63) Continuation of application No. PCT/EP2023/079127, filed on Oct. 19, 2023.

(30) Foreign Application Priority Data
Oct. 28, 2022 (EP) 22204526.2

(51) Int. Cl. D06P 5/30; D06P 1/38; D06P 1/673; D06P 5/20

(52) U.S. Cl. CPC D06P 5/30; D06P 1/38; D06P 1/6735; D06P 5/2072; D06P 5/2077

(57) ABSTRACT

An indigo-free fabric and its manufacturing method are disclosed. The indigo-free fabric has the visual appearance of a denim. The indigo-free fabric contains at least 70 wt % of cellulose fibers. The indigo-free manufacturing process includes inkjet printing a parallel straight lines pattern on at least part of the fabric, wherein each of the one or more inks contains a reactive dye and preferably has a viscosity from 5 cP to 9 cP, more preferably from 6 to 7 cP, at 25° C. and a shear rate 200-400 s⁻¹.

### CROSS-REFERENCE TO RELATED APPLICATIONS

This application is a Rule 53(b) Continuation of International Application No. PCT/EP2023/079127 filed Oct. 19, 2023, which claims priority based on European Patent Application No. 22204526.2 filed Oct. 28, 2022, the respective disclosures of all of the above are incorporated herein by reference in their entirety.

### FIELD OF THE INVENTION

The present invention relates to the technical field of denim fabrics and garments and processes for manufacturing said denim fabrics and garments.

### BACKGROUND OF THE INVENTION

Denim is a robust, durable fabric having a twill weave in which each warp yarn passes over a number of weft yarn, typically between two and four. The unique appearance of a denim fabric is largely attributable to the denim weave. Typically, only the warp yarn is dyed, such as with indigo, while the weft yarn remains white. Denim differs from other fabrics because it has a diagonal ribbing on one side.

The industrial process for manufacturing a denim fabric includes yarn production, yarn dyeing, weaving and finishing. Indigo, indigo derivatives and sulfur dyes are the main colorants used for dyeing the yarn used in the denim manufacturing process. Despite the fact that indigo, its derivatives and sulfur dyes are vat dyes, they have poor affinity for cellulose fibers in their reduced and solubilized form, unlike other vat dyes. Because of the poor dye uptake, the use of a multi-dip padding procedure with intermediate airing is typically required to achieve a progressive shade build-up. For example, for obtaining a dark shade, up to eight dips in a leuco-indigo bath are required, rendering the manufacturing process lengthy. In addition, the dyeing process generates large volumes of waste water. For example, dyeing of one pair of denim jeans consumes about 50-100 liters of water loaded with toxic reducing agents and alkali that remain as effluents in wastewater. Moreover, the currently used indigo dyeing process enables production of yarns and fabrics having a single shade, which need to be stored before being further processed, thereby increasing the production costs. A further drawback of the currently used manufacturing process is the back-staining of the denim fabric and/or garment during the finishing step, in particular during stone washing and/or enzymatic washing. The back-staining implies soiling of the weft thread and or the pocket lining by detached indigo or leuco-indigo, and leads to a decrease in the contrast between the white weft yarn and the blue warp yarn.

In consequence, there need is a for a process for manufacturing fabrics and garments having the visual appearance of a denim that mitigate the above-mentioned drawbacks. In particular there is a need for a cost-efficient and expedient process for manufacturing a fabric and garment thereof having the visual appearance of a denim that is environmentally friendly, particularly in terms of water and energy consumption, and enables the expedient production of a variety of fabrics having the visual appearance of a denim.

### SUMMARY OF THE INVENTION

Accordingly, it is an object of the present invention to provide an indigo-free process for manufacturing a fabric having a visual appearance of a denim comprising the following steps:
a) providing a non-coloured fabric containing at least 70 wt-% cellulose fibers;
b) contacting the non-coloured fabric with an alkali solution;
c) inkjet printing a parallel straight lines pattern on a back side of the fabric, or a region of said back side of the fabric, with one or more inks, to provide a visual appearance of a back side of a denim,
wherein
each of the one or more inks contains a reactive dye and preferably has a viscosity from 5 cP to 9 cP, more preferably from 6 to 7 cP, at 25° C. and a shear rate 200-400 s⁻¹;
d) drying the fabric;
e) inkjet printing a front side of the fabric, or a region of said front side of the fabric, with one or more inks, to provide a visual appearance of a front side of a denim,
wherein
each of the one or more inks contains a reactive dye and preferably has a viscosity from 5 cP to 9 cP, more preferably from 6 to 7 cP, at 25° C. and a shear rate 200-400 s⁻¹;

f) fixing the reactive dyes to the fabric; and

g) optionally washing and drying the fabric.

Also claimed and described herein is a process for manufacturing an indigo-free garment having a visual appearance of a denim, preferably a jeans, comprising the step of converting the fabric claimed and described herein into a garment.

A further aspect according to the present invention is directed to an indigo-free fabric having a visual appearance of a denim. The indigo-free fabric contains at least 70 wt-% of cellulose fibers. The cellulose fibers contain hydroxyl groups substituted with a moiety of general formula Chr-L-, wherein Chr is a chromogen, and -L- is a linker connecting the chromogen to the oxygen of the hydroxyl group. A back side of the fabric, or a region of said back side has an inkjet printed parallel straight lines pattern and a visual appearance of a back side of a denim. A front side of the fabric, or a region of said front side, has an inkjet printed pattern having a visual appearance of a front side of a denim.

An additional aspect according to the present invention relates to an indigo-free garment, preferably a jeans, made of the indigo-free denim fabric claimed and described herein, or obtained by the manufacturing process claimed and described herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-1C show a woven fabric according to the present invention and a sample of a jeans according to the present invention. The fabric and the garment were manufactured by the process claimed herein. The fabric and the garment have the visual appearance and the texture of a black denim.

FIG. 1A) a back side of the fabric having a printed parallel straight lines pattern. The lines are printed at an angle of 110° with respect to the rib, and have a width of 0.3 mm. The distance between each two adjacent lines is 0.7 mm;

FIG. 1B) a front side of the fabric having a printed pattern;

FIG. 1C) a sample of a jeans made with the fabric.

FIGS. 2A-2C show a woven fabric according to the present invention and a sample of a garment according to the present invention. The fabric and the garment were manufactured by the process claimed herein. The fabric and the garment have the visual appearance and the texture of a blue denim.

FIG. 2A) a back side of the fabric having a printed parallel straight lines pattern. The lines are printed at an angle of 110° with respect to the rib and have a width of 0.2 mm. The distance between each two adjacent lines is 0.6 mm;

FIG. 2B) a front side of the fabric having a printed pattern;

FIG. 2C) a sample of a jeans made with the fabric.

### DETAILED DESCRIPTION OF THE INVENTION

Thus, it is an object of the present invention to address the need for a cost-efficient process for manufacturing a fabric and garment thereof having the visual appearance of a denim, excellent colour fastness properties and no risk of back-staining during washing, which is environmentally friendly and enables the expedient production of a variety of fabrics having the visual appearance of a denim. The object is achieved by the manufacturing processes according to claims 1 and 10, the fabric according to claims 11 and 14 and the garment according to claim 15. Preferred embodiments are disclosed in the specification and the dependent claims.

The present invention will be described in more detail below.

Where the present description refers to “preferred” embodiments/features, combinations of these “preferred” embodiments/features are also deemed to be disclosed as long as the specific combination of the “preferred” embodiments/features is technically meaningful.

Unless otherwise stated, the following definitions shall apply in this specification:

As used herein, the term “a”, “an”, “the” and similar terms used in the context of the present invention (especially in the context of the claims) are to be construed to cover both the singular and plural unless otherwise indicated herein or clearly contradicted by the context.

As used herein, the term “and/or” means that either all or only one of the elements of said group may be present. For example, “A and/or B” means “only A, or only B, or both A and B”. In the case of “only A”, the term also covers the possibility that B is absent, i.e. “only A, but not B”.

As used herein, the terms “including”, “containing” and “comprising” are used herein in their open-ended, non-limiting sense. It is understood that the various embodiments, preferences and ranges may be combined at will. Thus, for instance a solution comprising a compound A may include other compounds besides A. However, the term “comprising” also covers, as a particular embodiment thereof, the more restrictive meanings of “consisting essentially of” and “consisting of, so that for instance “a solution comprising A, B and optionally C” may also (essentially) consist of A and B, or (essentially) consist of A, B and C. As used herein, the transitional phrase “consisting essentially of” (and grammatical variants) is to be interpreted as encompassing the recited materials or steps and those that do not materially affect the basic and novel characteristic(s) of the claimed invention. Thus, the term “consisting essentially of” should not be interpreted as equivalent of “comprising”.

As used herein, the term “about” means that the amount or value in question may be the specific value designated or some other value in its neighborhood. Generally, the term “about” denoting a certain value is intended to denote a range within ±5% of the value. As one example, the phrase “about 100” denotes a range of 100±5, i.e. the range from 95 to 105. Preferably, the range denoted by the term “about” denotes a range within ±3% of the value, more preferably ±1%. Generally, when the term “about” is used, it can be expected that similar results or effects according to the invention can be obtained within a range of ±5% of the indicated value.

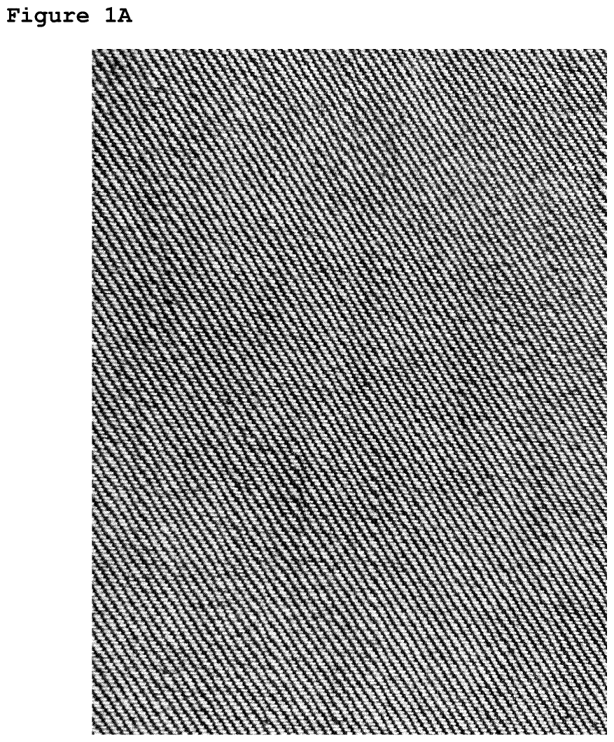

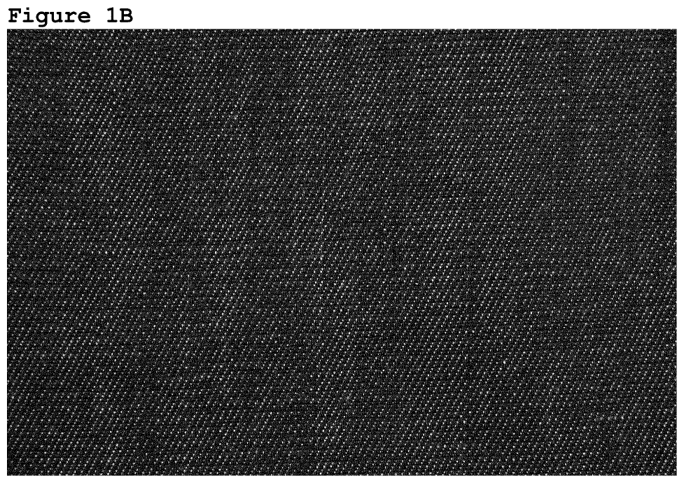

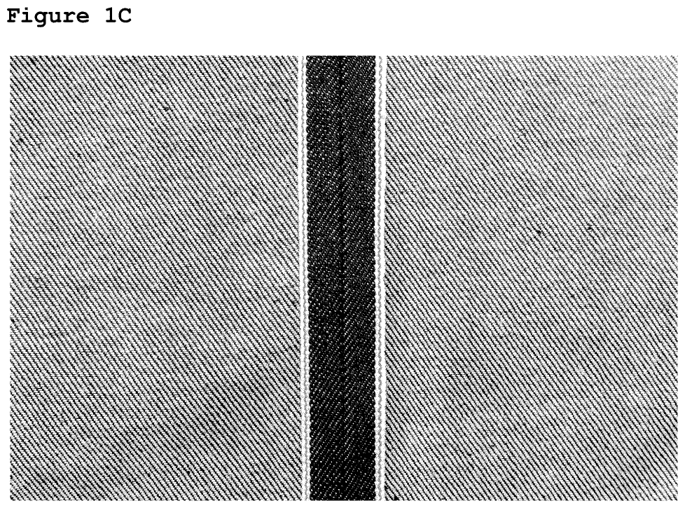

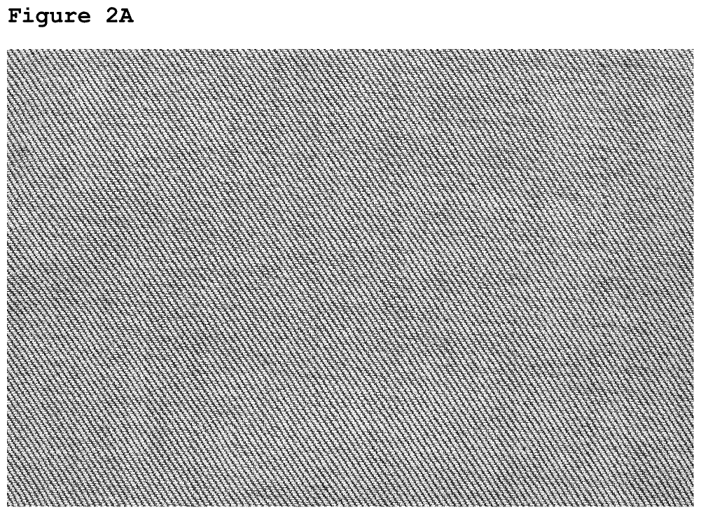

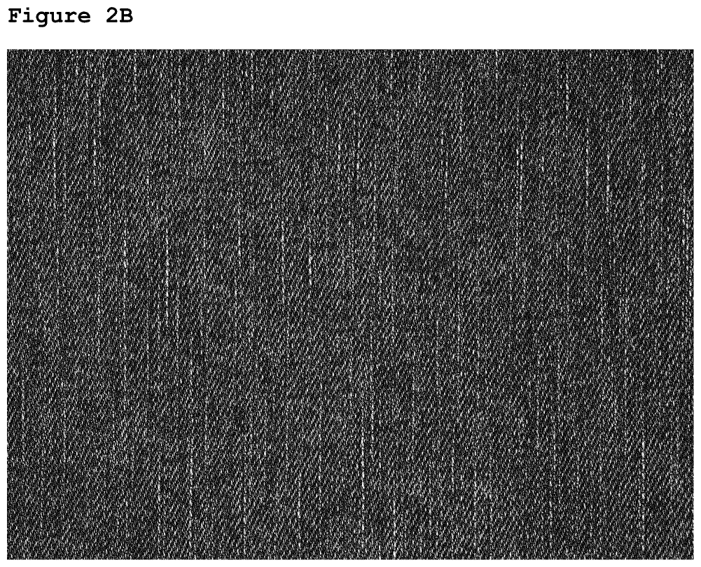

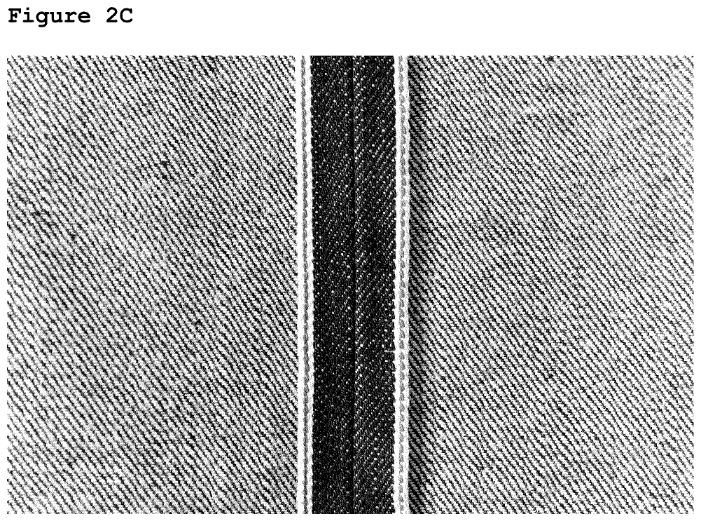

Surprisingly, it has been found that a process comprising the following steps:
a) providing a non-coloured fabric containing at least 70 wt-% cellulose fibers;
b) contacting the non-coloured fabric with an alkali solution;
c) inkjet printing, preferably piezo inkjet printing, a parallel straight lines pattern on a back side of the fabric, or a region of said back side of the fabric, with one or more inks, to provide a visual appearance of a back side of a denim,
wherein
each of the one or more inks contains a reactive dye and preferably has a viscosity from 5 cP to 9 cP, more preferably from 6 to 7 cP, at 25° C. and a shear rate 200-400 s⁻¹;
d) drying the fabric;
e) inkjet printing, preferably piezo inkjet printing, a front side of the fabric, or a region of said front side of the fabric, with one or more inks, to provide a visual appearance of a front side of a denim, wherein
each of the one or more inks contains a reactive dye and preferably has a viscosity from 5 cP to 9 cP, more preferably from 6 to 7 cP, at 25° C. and a shear rate 200-400 s⁻¹;
f) fixing the reactive dyes to the fabric; and
g) optionally washing and drying the fabric, provides an indigo-free fabric having the realistic visual appearance of a denim as illustrated for example by FIGS. 1 and 2. Owing to the colour gamut, high quality and printing speed (up to 600 m/h) of the inkjet printing technology, the manufacturing process claimed herein enables the production in a reproducible, cost-efficient, and expedient manner of a variety of fabrics, including low volume fabrics having the visual appearance of a denim. The use of the reactive dyes prevents the back-staining phenomenon encountered in the manufacturing processes using indigo as colorant. Advantageously, the manufacturing process claimed and described herein does not generate high volumes of waste water as it is the case for the manufacturing processes using indigo as colorant and is environmentally friendly, especially in terms of consumed energy and water.

Preferably, the parallel straight lines printed at step c) have a width from 0.1 mm to 2 mm, and a distance between each two adjacent lines is from 0.1 mm to 5 mm. More preferably, the width of the straight lines is from 0.1 mm to 1 mm and/or the distance between two adjacent lines is from 0.1 mm to 1 mm.

As used herein, the term “indigo-free process” relates to a process wherein neither indigo, nor an indigo-derivative is used for dyeing the fabric.

The term “indigo-derivative” refers to an indigo molecule substituted with one or more substituents. The substitution may take place at any of the available position on the indole moiety. Example of substituents include, but are not limited to, alkyl groups, alkoxy groups, aryl groups, aryloxy groups, acyl groups, fluoro group, chloro group, bromo group, and iodo group.

The term “non-coloured fabric” refers to a fabric made of fibers that have not been previously contacted with a colorant. The non-coloured fabric described herein may be any knitted or woven fabric containing at least 70 wt-% cellulose fibers.

Preferably, the non-coloured fabric is a cotton fabric, a lyocell fabric, a linen fabric, a viscose fabric, a hemp fabric, or a recycled cellulose fabric, more preferably a cotton fabric, optionally containing elastane fibers and/or polyester (PES) fibers. Examples of cotton fabrics include, but are not limited to, 100% cotton, a 708/30% blend of cotton and PES, and a 94-978/6-3% blend of cotton and elastane.

As used herein a region of the back/front side of the fabric encompasses at least 70%, preferably at least 80% of the total surface of the back/front side of the fabric. The complementary non-printed region of the back side and/or front side of the fabric may be used for personalizing the fabric, and the garment thereof, for example by adding a photo, a pattern or a logo.

To obtain a fabric having the visual appearance and the texture of a denim, the non-coloured fabric is preferably a woven fabric with a diagonal rib, such as a fabric having a twill weave in which each warp yarn passes over a number of weft yarns, and the parallel straight lines are printed at an angle from 60° to 120° with respect to the rib. Hence, a preferred manufacturing process according to the present invention comprises the following steps:
a) providing a non-coloured fabric containing at least 70 wt-% cellulose fibers, wherein the fabric is a woven fabric with a diagonal rib;
b) contacting the fabric with an alkali solution;
c) inkjet printing a parallel straight lines pattern on a back side of the fabric, or a region of said back side of the fabric, with one or more inks, to provide a visual appearance of a back side of a denim,
wherein
each of the one or more inks contains a reactive dye and preferably has a viscosity from 5 cP to 9 cP, more preferably from 6 to 7 cP, at 25° C. and a shear rate 200-400 s⁻¹,
the lines are printed at an angle from 60° to 120° with respect to the rib, and
preferably the lines have a width from 0.1 mm to 2 mm and a distance between each two adjacent lines is from 0.1 mm to 5 mm;
d) drying the fabric;
e) inkjet printing a front side of the fabric, or a region of said front side of the fabric, with one or more inks, to provide a visual appearance of a front side of a denim, wherein
each of the one or more inks contains a reactive dye and preferably has a viscosity from 5 cP to 9 cP, more preferably from 6 to 7 cP, at 25° C. and a shear rate 200-400 s⁻¹;
f) fixing the reactive dyes to the fabric; and
g) optionally washing and drying the fabric.

In the process claimed and described herein, step c) is conducted prior to step e) i.e. the back side of the fabric is printed prior to the front side of the fabric. This succession of the steps c), d) and e) reduces the risk of colour contamination from the front side and ensures a high quality of the printed parallel straight lines pattern on the back side of the fabric.

The use of the inkjet printing technology in the manufacturing process claimed and described herein enables the production of fabrics having different shades and/or colours on the front and back side of the fabric. In a preferred process according to the present invention the obtained fabric has at least two different shades on the front side. In a still preferred process according to the present invention, the obtained fabric has a first shade on a front side and a second shade on the back side, and the first shade is different from the second shade.

The one or more inks used for inkjet printing at step c) and e) of the manufacturing process claimed and described herein contain a reactive dye. As well known to the skilled person, a reactive dye contains a chromogen or chromophoric part, and one or more reactive functionalities, which are connected to the chromogen via a bridging unit. The chromogen or chromophoric part provides colour to the dye. The one or more reactive functionalities react through a nucleophilic substitution or a nucleophilic addition mechanism with the cellulosic fibers contained by the fabric to form a covalent bond. Owing to the strong covalent bond between the dye and the cellulosic fiber, reactive dyes provide remarkable fastness properties. Examples of suitable reactive dyes include, but are not limited to NOVACRON® C Yellow C-5G (Supplier: Huntsman), NOVACRON® C Orange C-G (Supplier: Huntsman), NOVACRON® C Red C-2G (Supplier: Huntsman), NOVACRON® C Red C-R (Supplier: Huntsman), NOVACRON® C Blue C-4R (Supplier: Huntsman), NOVACRON® C Turqouise C-GN (Supplier: Huntsman), NOVACRON® C Black C—N (Supplier: Huntsman), EVERPLUS Yellow L-6G (Supplier: EVERLIGHT), EVERPLUS Orange L-2R (Supplier: EVERLIGHT), EVERPLUS CYAN L-G (Supplier: EVERLIGHT), EVERPLUS Blue L-3R (Supplier: EVERLIGHT; CAS Nr: 61968-93-2), EVERPLUS RED L-6B (Supplier: EVERLIGHT; CAS Nr.: 113653-03-5), and EVERPLUS BLACK SGR (Supplier: EVERLIGHT; CAS Nr.: 17095-24-8).

Preferably the one or more inks used at step c) and or e) of the manufacturing process claimed and described herein have a viscosity from 5 cP to 9 cP, more preferably from 6 to 7 cP, at 25° C. and a shear rate 200-400 s⁻¹, and/or contain
from 10 to 25 wt-% of a reactive dye;
from 25 to 28 wt-% of a humectant;
from 0.25 to 1 wt-% of a biocide;
from 0.02 to 0.5 wt-% of a surfactant;
from 0.5 to 2 wt-% of a complexing agent;
from 2 to 15 wt-% of a solubilizing agent;
from 0.25 to 1% of an acid;
up to 2 wt-% of a thickener; and
water as balance.

The ink may contain 15 wt-% of NOVACRON® C Yellow C-5G, or 17 wt-% NOVACRON® C Orange C-G, or 18 wt-% NOVACRON® C Red C-2G, or 20 wt-% NOVACRON® C Red C-R, or 21 wt-% NOVACRON® C Blue C-4R, or 18 wt-% NOVACRON® C Turquoise C-GN, or 23 wt-% NOVACRON® C Black C—N.

Examples of humectants, include but are not limited to, propylene glycol (IUPAC name: propane-1,2-diol). Examples of biocides, include but are not limited to, Proxel GXL (IUPAC name: benzisothiazolinone; Supplier: Azelis Switzerland). Examples of surfactants, include but are not limited to, Zonyl FSO (fluorosurfactant commercially available from Sigma-Aldrich). Examples of complexing agents, include but are not limited to, Trilon® M (Supplier: BASF). Examples of solubilizing agents, include but are not limited to, caprolactam (IUPAC name: azepan-2-one). Examples of acids, include but are not limited to, citric acid. Examples of thickeners, include but are not limited to, polyglycol P41 (commercially available from Omya).

Without being bound by the theory, it is considered that in the manufacturing process claimed and described herein, a CMYK set of blendable inks (i.e. a Cyan (C) ink, a Magenta (M) ink, an Yellow (Y) ink and a Black (K) ink) is sufficient to achieve the full colour space of a denim. To enable extended colour space, additional inks such as Orange, Blue, Green and Grey inks may be used at step c) and/or e). An example of a suitable ink for the present process is an ink having the following composition:

| Ingredient | Commercial name | Amount wt-% |
|---|---|---|
| Reactive dye | NOVACRON ® C Red C-R | 18 |
| Humectant | 1,2-propylenglycol | 25 |
| Biocide | Proxel GXL | 0.25 |
| Surfactant | Zonyl FSO | 0.025 |
| Complexing agent | Trilon M | 1 |
| Solubilizing agent | caprolactam | 5 |
| Acid | citric acid | 0.5 |
| Solvent | water | 50.225 |

Further inks suitable for the inventive manufacturing process are SwissJet NR7 HD inks (e.g.: SwissJet NR7 HD Yellow, SwissJet NR7 HD Magenta, SwissJet NR7 HD Cyan, SwissJet NR7 HD Black) commercially available from SPC Switzerland.

In a preferred embodiment, the reactive dye present in the one or more inks used at step c) and in the one or more inks used at step e) is a mono-reactive dye containing one reactive functionality. The reactive functionality is preferably selected from a mono-chlorotriazine reactive functionality, a mono-fluorotriazine reactive functionality, and a mono-vinylsulfone reactive functionality, more preferably from a mono-chlorotriazine reactive functionality, and a mono-vinylsulfone reactive functionality. Examples of suitable mono-reactive dyes include, but are not limited to EVERPLUS Yellow L-6G (Supplier: EVERLIGHT), EVERPLUS Orange L-2R (Supplier: EVERLIGHT), EVERPLUS CYAN L-G (Supplier: EVERLIGHT), EVERPLUS Blue L-3R (Supplier: EVERLIGHT; CAS Nr: 61968-93-2), EVERPLUS RED L-6B (Supplier: EVERLIGHT; CAS Nr.: 113653-03-5), and EVERPLUS BLACK SGR (Supplier: EVERLIGHT; CAS Nr.: 17095-24-8). In this embodiment, step b) preferably comprises:
b-1) padding the non-coloured fabric with an aqueous alkali solution containing:
   from 120 to 200 g/L urea;
   from 80 to 150 g/L of a thickening agent, such as an alginate thickening agent;
   from 30 to 45 g/L sodium carbonate;
   from 2 to 5 g/L of a de-aerating agent, such as Croscolor PTM (supplier: Eurodye-CTC); and
   from 10 to 20 g/L of an anti-reducing agent, such as Croscolor ARI (supplier: Eurodye-CTC); and
b-2) drying the fabric of step b-1) for at least 1 minute at a temperature from 120° C. to 140° C.
   The aqueous alkali solution is preferably free of organic solvent (i.e. water is the sole solvent contained therein). As well known in the field of textile chemistry, “a de-aerating agent”, also known as “an air release agent” or “a deaerator”, is a textile auxiliary designed for rapid air release from fabrics e.g. during the fabric pretreatment/dying/finishing process. Owing to their wetting, defoaming and penetrative properties, de-aerating agents remove hidden air pockets from fabrics, including tightly packed and tightly woven fabrics, for e.g. during pre-treatment thereby ensuring better penetration and performance of inks. Examples of suitable de-aerating agents include known silicone-based de-aerating agents and sodium hexametaphosphate (SHMP). Examples of commercially available de-aerating agents include Croscolor PTM (supplier: Eurodye-CTC), sodium hexametaphosphate, DYNAPAN 360F (supplier: SILITEX), and TEGO Antifoam 1488 (supplier: EVONIK). As well known in the field of textile chemistry, “an anti-reducing agent” or “an anti-reduction agent” is an oxidizing agent that prevents reduction of dyes, e.g. reactive dyes, during the printing and dyeing process. As used herein, the term anti-reducing agent refers to an anti-reducing agent for reactive dyes and includes sodium meta nitro benzenesulfonate and the de-aerating agent sold under the trade name Croscolor ARI.

Preferably, step b-2) is conducted by subjecting the fabric obtained at step b-1) to an air having a temperature from 120° C. to 140° C. for less than 5 minutes, preferably less than 3 minutes, such as 2 minutes.

To fix the mono-reactive dyes to the fabric, the fabric obtained at step e) is preferably steamed for 5 to 15 min, preferably for 7 to 13 min, at a temperature from 100° C. to 105° C. Hence, preferably step f) comprises steaming the fabric for 5 to 15 min at a temperature from 100° C. to 105° C.

In an alternative more preferred embodiment, the reactive dye present in the one or more inks used at step c) and in the one or more inks used at step e) is a bi-reactive dye containing a first reactive functionality and a second reactive functionality. The first reactive functionality and the second reactive functionality are independently of each other selected from a mono-chlorotriazine reactive functionality, a mono-fluorotriazine reactive functionality, a mono-vinylsulfone reactive functionality, and a fluorochloropyrimidine reactive functionality. The bi-reactive dye may contain for example a mono-vinylsulfone reactive functionality and a fluorochloropyrimidine reactive functionality, or a mono-fluorotriazine reactive functionality and a mono-vinylsulfone reactive functionality. Examples of suitable bi-reactive dyes include, but are not limited to NOVACRON® C Yellow C-5G (Supplier: Huntsman), NOVACRON® Orange C-G (Supplier: Huntsman), NOVACRON® C Red C-2G (Supplier: Huntsman), NOVACRON® C Red C-R (Supplier: Huntsman), NOVACRON® C Blue C-4R (Supplier: Huntsman), NOVACRON® C Turqouise C-GN (Supplier: Huntsman), and NOVACRON® C Black C—N (Supplier: Huntsman). In this embodiment, step b) preferably comprises:
b-3) padding the non-coloured fabric with an aqueous alkali solution containing:
   from 15 to 35 g/L, preferably from 15 to 25 g/L, sodium hydroxide;
   from 60 to 80 g/L, preferably 70 g/L, sodium alginate; and
b-4) drying the fabric of step b-3) for at least 1 minute, preferably for 2 minutes, at a temperature from 120° C. to 140° C. The aqueous alkali solution is preferably free of organic solvent (i.e. water is the sole solvent contained therein). Preferably, step b-4) is conducted by subjecting the fabric obtained at step b-3) to an air having a temperature from 120° C. to 140° C. To fix the bi-reactive dyes to the fabric, the fabric obtained at step e) is preferably maintained for 5 to 9 hours at a temperature from 20° C. to 30° C. Hence, preferably step f) comprises maintaining the fabric for 5 to 9 hours at a temperature from 20° C. to 30° C.

At step d) of the inventive manufacturing process, the fabric obtained at step c) is dried to remove the solvent contained by the one or more inks used for printing the back side of the fabric. Preferably, the drying is conducted by subjecting the fabric to a hot air (e.g. an air having a temperature from 120° C. to 140° C.).

The process claimed and described herein may optionally comprise step g)
g) washing and drying the fabric. The washing may include soaping the fabric, followed by rinsing with water. The washed fabric may be subsequently dried by exposure to hot air (e.g. an air having a temperature from 120° C. to 140° C.).

Advantageously, steps c)-e) of the process claimed and described are fully automated and can be conducted on a digital printing machine for direct printing of fabrics (e.g.: Reggiani ReNoir PRO Digital Printing Machine commercially available from EFI) coupled with an air dryer.

A second aspect according to the present invention is directed to a process for manufacturing an indigo-free garment having a visual appearance of a denim comprising the step of converting the denim fabric obtained into a garment. The garment having the visual appearance of a denim is preferably selected from a jeans, a jacket, a shirt, a skirt, and a dress. In a preferred embodiment, the garment having the visual appearance of a denim is a jeans.

The process for manufacturing the indigo-free garment claimed and described herein may further contain a step h):
h) finishing the garment.
   The finishing step enables altering the appearance of the garment and thereby customizing the garment, for example by removing colour, producing contrast effects, such as an abraded visual effect, and/or softening the surface of the fabric. Preferably, where present, the finishing step involves laser treatment, and subsequent washing with water to remove the degraded reactive dye. Laser treatment is a quick, accurate and the most eco-friendly finishing process that enables customization of the garment by production of cuts, holes, fraying and ‘vintage’ effects. Advantageously, in the manufacturing process described herein, no back-staining takes place.

A third aspect according to the present invention is directed to an indigo-free fabric having a visual appearance of a denim. The fabric contains at least 70 wt-% of cellulose fibers. The cellulose fibers contain hydroxyl groups substituted with a moiety of general formula Chr-L-, wherein Chr is a chromogen, and -L-is a linker connecting the chromogen to the oxygen of the hydroxyl group. A back side of the fabric, or a region of said back side has an inkjet printed parallel straight lines pattern, wherein preferably a distance between each two adjacent lines is from 0.1 mm to 5 mm, and the lines have a width from 0.1 mm to 2 mm. A front side of the fabric, or a region of said front side, has an inkjet printed pattern having the appearance of a denim. The indigo-free fabric claimed and described herein presents excellent colour fastness properties and does not risk a back-staining phenomenon during washing.

The chromogen Chr is a chromogen originating from a reactive dye, such as a mono-reactive dye or a bi-reactive dye. The linker -L- connecting the chromogen to the oxygen of the hydroxyl group includes the bridging unit of a reactive dye and a rest of the reactive functionality (e.g.: mono-chlorotriazine, a mono-fluorotriazine, mono-vinylsulfone of said reactive dye) obtained after nucleophilic substitution or nucleophilic addition with the hydroxy group of the cellulosic fibers. For example if the reactive dye used for printing the fabric has the following structure

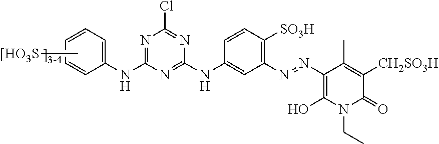

the chromogen Chr will have the following structure:

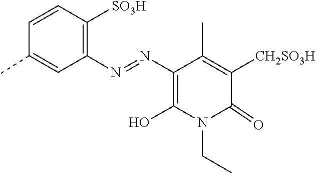

and the linker-L-will have the following structure:

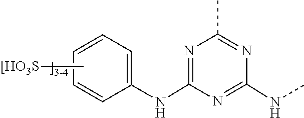

A preferred embodiment according to the present invention is directed to an indigo-free fabric as described herein, wherein the fabric is a woven fabric with a diagonal rib and the parallel straight lines are printed at an angle from 60° to 120° with respect to the rib. Such indigo-free fabric has not only the visual appearance, but also the texture of a denim.

The indigo-free fabric described herein may have different colours and/or shades on the front side and on the back side. For example, the indigo-free fabric may have at least two different shades on the front side or the fabric may have a first shade on the front side and a second shade on the back side, with the first shade being different from the second shade.

A fourth aspect according to the present invention is directed to an indigo-free fabric having a visual appearance of a denim obtained by the process claimed and described herein.

A fifth aspect according to the present invention relates to an indigo-free garment having a visual appearance of a denim, comprising the indigo-free fabric claimed and described herein. The garment is preferably selected preferably selected from a jeans, a jacket, a shirt, a skirt, and a dress, and more preferably is a jeans.

To further illustrate the invention, the following examples are provided. These examples are provided with no intend to limit the scope of the invention.

### Example

A non-coloured woven fabric containing at least 70 wt-% cellulose fibers (supplier: Evlox) was padded (pick-up: 70-80%) with an aqueous alkali solution containing 120 g/L urea, 100 g/L alginate thickening agent, 30 g/L sodium carbonate, 2 g/L Croscolor PTM (supplier: Eurodye-CTC; de-aerating agent), and 10 g/L Croscolor ARI (supplier: Eurodye-CTC; anti-reducing agent).

Following drying for 2 minutes at a temperature of between 120° C. to 140° C., the roll of fabric was loaded on a Reggiani ReNoir PRO Digital Printing Machine (Manufacturer: EFI) coupled with an air dryer for inkjet printing a parallel straight lines pattern on its back side, drying the fabric by exposure to hot air (120° C.-140° C.) for 1 minute, and inkjet printing a pattern on the front side of the fabric. The colour containers of the printing machine were filled with a SwissJet NR7 HD Yellow ink, a SwissJet NR7 HD Magenta ink, a SwissJet NR7 HD Cyan ink and a SwissJet NR7 HD Black ink, all commercially available from SPC Switzerland.

Afterwards, the fabric was steamed for 8 minutes at about 102° C. to fix the reactive dye.

The inkjet printed fabric was subsequently soaped at a temperature of 95° C. to 98° C., and dried with hot air (120° C.-140° C.) for 2 minutes.

A jeans was manufactured with the fabric obtained as described above.

FIGS. 1A to 2C are photographs of two fabrics and jeans (FIGS. 1A-1C: black fabric and jeans; FIGS. 2A-2C: blue fabric and jeans) obtained as described above.

1. An indigo-free process for manufacturing a fabric having a visual appearance of a denim comprising the following steps:
a) providing a non-coloured fabric containing at least 70 wt-% cellulose fibers;
b) contacting the non-coloured fabric with an alkali solution;
c) inkjet printing a parallel straight lines pattern on a back side of the fabric, or a region of said back side of the fabric, with one or more inks, to provide a visual appearance of a back side of a denim,
wherein
each of the one or more inks contains a reactive dye;
d) drying the fabric;
e) inkjet printing a front side of the fabric, or a region of said front side of the fabric, with one or more inks, to provide a visual appearance of a front side of a denim, wherein
each of the one or more inks contains a reactive dye;
f) fixing the reactive dyes to the fabric; and
g) optionally washing and drying the fabric.

2. The process according to claim 1, wherein a distance between each two adjacent lines is from 0.1 mm to 5 mm, and the lines have a width from 0.1 mm to 2 mm.

3. The process according to claim 2, wherein the fabric is a woven fabric with a diagonal rib and the parallel straight lines are printed at an angle from 60° to 120° with respect to the rib.

4. The process according to claim 1, wherein the reactive dye present in the one or more inks used at step c) and in the one or more inks used at step e) is a mono-reactive dye containing one reactive functionality, preferably selected from a mono-chlorotriazine reactive functionality, a mono-fluorotriazine reactive functionality, and a mono-vinylsulfone reactive functionality.

5. The process according to claim 4, wherein step b) comprises:
b-1) padding the non-coloured fabric with an aqueous alkali solution containing:
from 120 to 200 g/L urea;
from 80 to 150 g/L of a thickening agent;
from 30 to 45 g/L sodium carbonate;
from 2 to 5 g/L of a de-aerating agent; and
from 10 to 20 g/L of an anti-reducing agent; and
b-2) drying the fabric of step b-1) for at least 1 minute at a temperature from 120° C. to 140° C.

6. The process according to claim 5, wherein step f) comprises steaming the fabric for 5 to 15 min at a temperature from 100° C. to 105° C.

7. The process according to claim 1, wherein the reactive dye present in the one or more inks used at step c) and in the one or more inks used at step e) is a bi-reactive dye containing a first reactive functionality and a second reactive functionality, with first reactive the functionality and the second reactive functionality being independently of each other selected from a mono-chlorotriazine reactive functionality, a mono-fluorotriazine reactive functionality, a mono-vinylsulfone reactive functionality, and a fluorochloropyrimidine reactive functionality.

8. The process according to claim 7, wherein step b) comprises:
b-3) padding the non-coloured fabric with an aqueous alkali solution containing:
from 15 to 35 g/L sodium hydroxide;
from 60 to 80 g/L sodium alginate; and
b-4) drying the fabric of step b-3) for at least 1 minute at a temperature from 120° C. to 140° C.

9. The process according to claim 8, wherein step f) comprises maintaining the fabric for 5 to 9 hours at a temperature from 20° C. to 30° C.

10. A process for manufacturing an indigo-free garment having a visible appearance of a denim comprising the step of converting the fabric according to claim 1 into a garment.

11. An indigo-free fabric having a visual appearance of a denim, wherein
a back side of the fabric, or a region of said back side, has an inkjet printed parallel straight lines pattern and a visual appearance of a back side of a denim,
a front side of the fabric, or a region of said front side, has an inkjet printed pattern having the visual appearance of a front side of a denim, and
said fabric contains at least 70 wt-% of cellulose fibers containing hydroxyl groups substituted with a moiety of general formula Chr-L-, wherein Chr is a chromogen, and -L- is a linker connecting the chromogen to the oxygen of the hydroxyl group.

12. The fabric according to claim 11, wherein a distance between each two adjacent lines is from 0.1 mm to 5 mm, and the lines have a width from 0.1 mm to 2 mm.

13. The fabric according to claim 12, wherein the fabric is a woven fabric with a diagonal rib and the parallel straight lines are printed at an angle from 60° to 120° with respect to the rib.

14. The fabric according to claim 11, wherein the inkjet printed parallel straight lines pattern is a piezo inkjet printed parallel straight lines pattern and the inkjet printed pattern is a piezo inkjet printed pattern.

15. An indigo-free garment having a visual appearance of a denim, comprising the indigo-free fabric according to claim 11.

16. The process according to claim 1, wherein each of the one or more inks has a viscosity from 5 cP to 9 cP at 25° C. and a shear rate 200-400 s⁻¹.

17. The process according to claim 1, wherein each of the one or more inks has a viscosity from 6 to 7 cP at 25° C. and a shear rate 200-400 s⁻¹.

18. The process according to claim 10, wherein the indigo-free garment is jeans.

19. The indigo-free garment according to claim 15, wherein the indigo-free garment is jeans.
